(19) United States
(12) Patent Application Publication
(10) Pub. No.: US 2021/0024038 A1
(43) Pub. Date: Jan. 28, 2021

(54) MANIFOLD FOR VEHICLE SENSOR CLEANING

(71) Applicant: Ford Global Technologies, LLC, Dearborn, MI (US)

(72) Inventors: VENKATESH KRISHNAN, Canton, MI (US); SEGUNDO BALDOVINO, Novi, MI (US)

(73) Assignee: Ford Global Technologies, LLC, Dearborn, MI (US)

(21) Appl. No.: 16/523,574

(22) Filed: Jul. 26, 2019

(51) Int. Cl. B60S 1/56; F16K 31/06; B60S 1/48

(52) U.S. Cl. CPC B60S 1/56; B60S 1/0848; B60S 1/481; F16K 31/06

(57) ABSTRACT

A fluid apparatus includes a first manifold section including a straight pipe defining an axis, an inlet fluidly connected to the pipe and in line with the axis, and three first cylindrical tubes fluidly connected to and elongated from the pipe; a second manifold section fixed relative to the first manifold section and including three second cylindrical tubes each aligned with a respective one of the first cylindrical tubes; and three solenoid valves each press-fit into a respective one of the first cylindrical tubes and into a respective one of the second cylindrical tubes.

### BACKGROUND

Vehicles, such as autonomous or semi-autonomous vehicles, typically include a variety of sensors. Some sensors detect internal states of the vehicle, for example, wheel speed, wheel orientation, and engine and transmission variables. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back. Some sensors are communications devices, for example, vehicle-to-infrastructure (V2I) or vehicle-to-vehicle (V2V) devices. Sensor operation can be affected by obstructions, e.g., dust, snow, insects, etc.

### BRIEF DESCRIPTION OF THE DRAWINGS

FIG. 1 is a perspective view of an example vehicle including a sensor assembly.

FIG. 2 is a diagram of a cleaning system for the sensor assembly.

FIG. 3 is a perspective view of a manifold of the cleaning system.

FIG. 4 is a cross-sectional side view of the manifold.

FIG. 5 is a cross-sectional view of a solenoid valve of the sensor assembly.

FIG. 6 is a top view of a section of the manifold.

### DETAILED DESCRIPTION

A fluid apparatus includes a first manifold section including a straight pipe defining an axis, an inlet fluidly connected to the pipe and in line with the axis, and at least three first cylindrical tubes fluidly connected to and elongated from the pipe; a second manifold section fixed relative to the first manifold section and including at least three second cylindrical tubes each aligned with a respective one of the first cylindrical tubes; and at least three solenoid valves each press-fit into a respective one of the first cylindrical tubes and into a respective one of the second cylindrical tubes.

Each solenoid valve may control flow from the pipe through the respective one of the first cylindrical tubes and then through the respective one of the second cylindrical tubes.

The solenoid valves may be independently actuatable.

The pipe may have an increasing cross-sectional area along the axis from the first cylindrical tube closest to the inlet to the first cylindrical tube farthest from the inlet.

The pipe may have a circular cross-section. A diameter of the circular cross-section may continuously increase from the first cylindrical tube closest to the inlet to the first cylindrical tube farthest from the inlet.

Cross-sectional areas of the first cylindrical tubes may be substantially equal to each other.

Each respective pairing of one of the first cylindrical tubes and one of the second cylindrical tubes may define a common axis. Each solenoid valve may extend along the respective axis from a first end inside the respective first cylindrical tube to a second end inside the respective second cylindrical tube, and the fluid apparatus may further include an elastomeric bushing inside each first cylindrical tube and contacting the respective first end of the respective solenoid valve. Each elastomeric bushing may be a first elastomeric bushing, and the fluid apparatus may further include a second elastomeric bushing inside each second cylindrical tube and contacting the respective second end of the respective solenoid valve.

The first manifold section may include a first bolt hole; the second manifold section may include a second bolt hole aligned with the first bolt hole; and the fluid apparatus may further include a bolt extending through the bolt holes, and an elastomeric bushing through which the bolt extends. The elastomeric bushing may be a third elastomeric bushing, the fluid apparatus may further include a fourth elastomeric bushing through which the bolt extends, and the third elastomeric bushing may contact the first manifold section and may be spaced from the second manifold section, and the fourth elastomeric bushing may contact the second manifold section and may be spaced from the first manifold section.

The first cylindrical tubes may extend parallel to each other and transverse from the pipe. The first cylindrical tubes may be arranged in series along the pipe with each first cylindrical tube equally spaced from the consecutive first cylindrical tubes. The pipe may be sealed other than the inlet and the first cylindrical tubes.

The first cylindrical tubes may extend perpendicular to the pipe.

The first manifold section may be a single piece, and the second manifold section may be a single piece.

The fluid apparatus may further include a pump fluidly connected to the inlet.

With respect to the Figures, a fluid apparatus 32 for a vehicle 30 includes a first manifold section 34 including a straight pipe 36 defining an axis A, an inlet 38 fluidly connected to the pipe 36 and in line with the axis A, and at least three first cylindrical tubes 40, 42, 44, 46, 48, 50 fluidly connected to and elongated from the pipe 36; a second manifold section 52 fixed relative to the first manifold section 34 and including at least three second cylindrical tubes 54, 56, 58, 60, 62, 64 each aligned with a respective one of the first cylindrical tubes 40, 42, 44, 46, 48, 50; and three solenoid valves 66 each press-fit into a respective one of the first cylindrical tubes 40, 42, 44, 46, 48, 50 and into a respective one of the second cylindrical tubes 54, 56, 58, 60, 62, 64.

The fluid apparatus 32 provides for a compact packaging of components, providing greater design flexibility for other components of the vehicle 30. The fluid apparatus 32 permits easy manufacturability and assembly, with the first and second manifold sections 34, 52 able to be molded and then press fit together using the solenoid valves 66. As described below, the fluid apparatus 32 is able to only transmit a low level of vibrations to the rest of the vehicle 30, and the fluid apparatus 32 can provide an even flow rate and pressure through the second cylindrical tubes 54, 56, 58, 60, 62, 64.

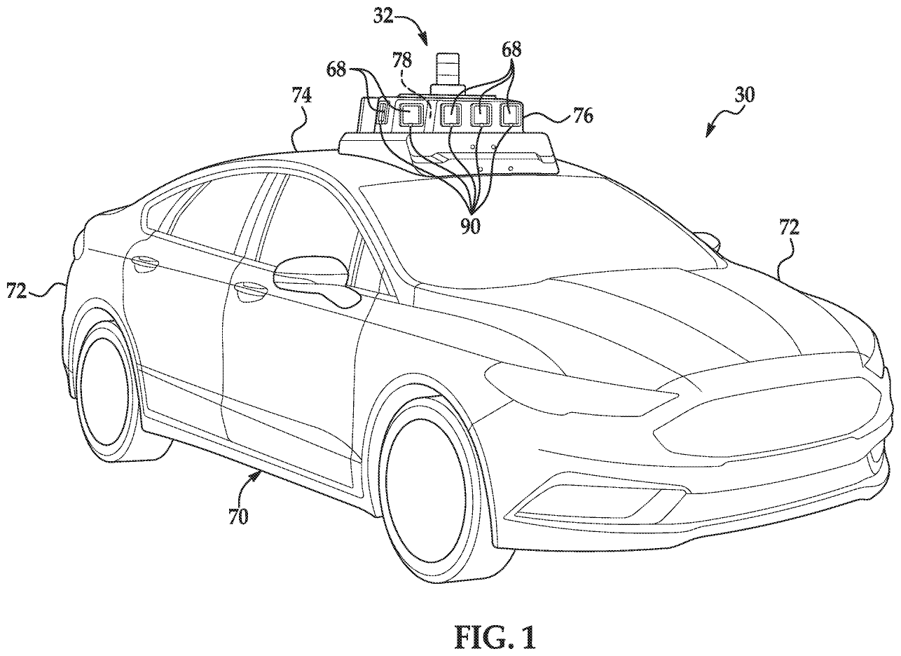

With reference to FIG. 1, the vehicle 30 may be any passenger or commercial automobile such as a car, a truck, a sport utility vehicle, a crossover, a van, a minivan, a taxi, a bus, etc.

The vehicle 30 may be an autonomous vehicle. A computer can be programmed to operate the vehicle 30 independently of the intervention of a human driver, completely or to a lesser degree. The computer may be programmed to operate the propulsion, brake system, steering, and/or other vehicle systems based at least in part on data received from sensors 68. For the purposes of this disclosure, autonomous operation means the computer controls the propulsion, brake system, and steering without input from a human driver; semi-autonomous operation means the computer controls one or two of the propulsion, brake system, and steering and a human driver controls the remainder; and nonautonomous operation means a human driver controls the propulsion, brake system, and steering.

The vehicle 30 includes a body 70. The vehicle 30 may be of a unibody construction, in which a frame and the body 70 of the vehicle 30 are a single component. The vehicle 30 may, alternatively, be of a body-on-frame construction, in which the frame supports the body 70 that is a separate component from the frame. The frame and body 70 may be formed of any suitable material, for example, steel, aluminum, etc.

The body 70 includes body panels 72 partially defining an exterior of the vehicle 30. The body panels 72 may present a class-A surface, e.g., a finished surface exposed to view by a customer and free of unaesthetic blemishes and defects. The body panels 72 include, e.g., a roof 74, etc.

A housing 76 for the sensors 68 is attachable to the vehicle 30, e.g., to one of the body panels 72 of the vehicle 30, e.g., the roof 74. For example, the housing 76 may be shaped to be attachable to the roof 74, e.g., may have a shape matching a contour of the roof 74. The housing 76 may be attached to the roof 74, which can provide the sensors 68 with an unobstructed field of view of an area around the vehicle 30. The housing 76 may be formed of, e.g., plastic or metal.

The housing 76 may enclose and define a cavity 78. One or more of the body panels 72, e.g., the roof 74, may partially define the cavity 78, or the housing 76 may fully enclose the cavity 78. The housing 76 may shield contents of the cavity 78 from external elements such as wind, rain, debris, etc.

The sensors 68 are disposed in the cavity 78 of the housing 76. The sensors 68 may detect the location and/or orientation of the vehicle 30. For example, the sensors 68 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 68 may detect the external world, e.g., objects and/or characteristics of surroundings of the vehicle 30, such as other vehicles, road lane markings, traffic lights and/or signs, pedestrians, etc. For example, the sensors 68 may include radar sensors, scanning laser range finders, light detection and ranging (LIDAR) devices, and image processing sensors such as cameras. The sensors 68 may include communications devices, for example, vehicle-to-infrastructure (V2I) or vehicle-to-vehicle (V2V) devices.

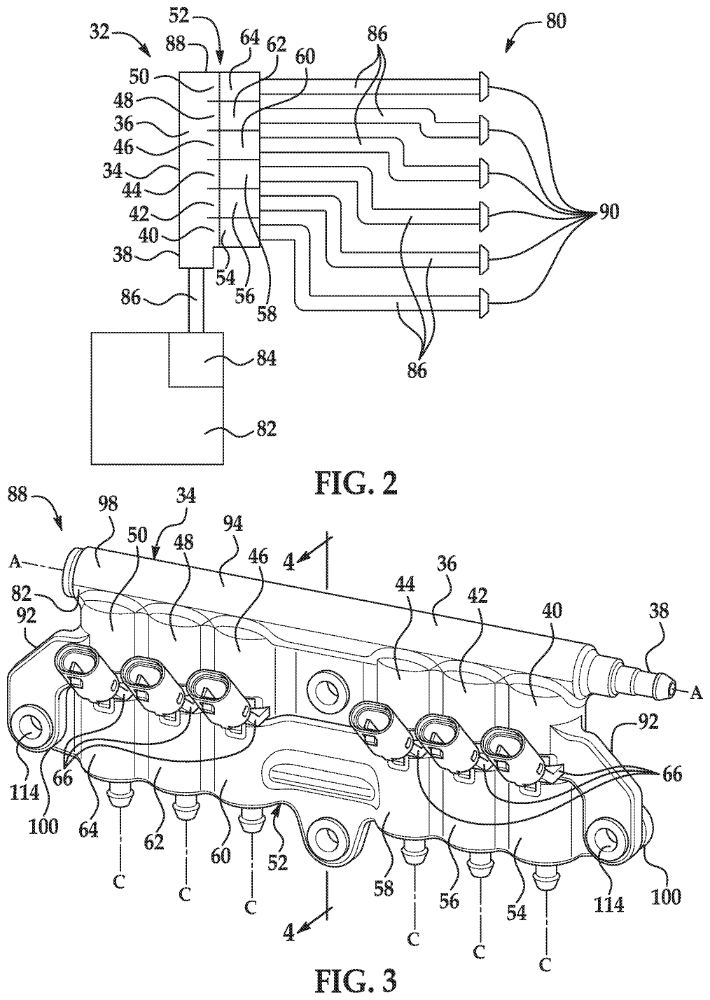

With reference to FIG. 2, a cleaning system 80 of the vehicle 30 includes a reservoir 82, a pump 84, supply lines 86, a manifold 88 (which includes the first manifold section 34 and the second manifold section 52), and nozzles 90. The reservoir 82, the pump 84, and the nozzles 90 are fluidly connected to each other (i.e., fluid can flow from one to the other) via the supply lines 86 and the manifold 88. The cleaning system 80 distributes washer fluid stored in the reservoir 82 to the nozzles 90. “Washer fluid” refers to any liquid stored in the reservoir 82 for cleaning. The washer fluid may include solvents, detergents, diluents such as water, etc.

The reservoir 82 is a tank fillable with liquid, e.g., washer fluid for window cleaning. The reservoir 82 may be disposed in a front of the vehicle 30, specifically, in an engine compartment forward of a passenger cabin. The reservoir 82 may store the washer fluid only for supplying the sensors 68 or also for other purposes, such as supply to a windshield. Alternatively, the reservoir 82 may be disposed in the cavity 78 of the housing 76.

The pump 84 can force the washer fluid through the supply lines 86 and the manifold 88 to the nozzles 90 with sufficient pressure that the washer fluid sprays from the nozzles 90. The pump 84 is fluidly connected to the reservoir 82. The pump 84 may be attached to or disposed in the reservoir 82. The pump 84 is fluidly connected to the manifold 88, specifically to the inlet 38 of the first manifold section 34 of the manifold 88.

The supply lines 86 extend from the pump 84 to the manifold 88 (i.e., to the inlet 38 of the first manifold section 34 of the manifold 88) and from the manifold 88 (i.e., the second cylindrical tubes 54, 56, 58, 60, 62, 64 of the second manifold section 52 of the manifold 88) to the nozzles 90. The supply lines 86 may be, e.g., flexible tubes.

As will be described in more detail below, the manifold 88 includes first manifold section 34 and the second manifold section 52. The first manifold section 34 includes the pipe 36, the inlet 38, and the first cylindrical tubes 40, 42, 44, 46, 48, 50. The second manifold section 52 includes the second cylindrical tubes 54, 56, 58, 60, 62, 64. The inlet 38 receives washer fluid from the pump 84 via the supply lines 86. The manifold 88 can direct washer fluid entering the inlet 38 to any combination of respective pairs of the first cylindrical tubes 40, 42, 44, 46, 48, 50 and second cylindrical tubes 54, 56, 58, 60, 62, 64, i.e., can independently block or open each of the respective pairs of the first cylindrical tubes 40, 42, 44, 46, 48, 50 and second cylindrical tubes 54, 56, 58, 60, 62, 64. The manifold 88 can be disposed in the cavity 78 of the housing 76 and fixed relative to the housing 76.

Each of the nozzles 90 is fluidly connected to one of the second cylindrical tubes 54, 56, 58, 60, 62, 64 via one of the supply lines 86. The nozzles 90 are positioned to eject the washing fluid to clear obstructions from the fields of view of the sensors 68, e.g., aimed at the sensors 68 or at windows (not labeled) for the sensors 68. The pressure of the washer fluid exiting the nozzles 90 can dislodge or wash away obstructions that may impede the fields of view of the sensors 68.

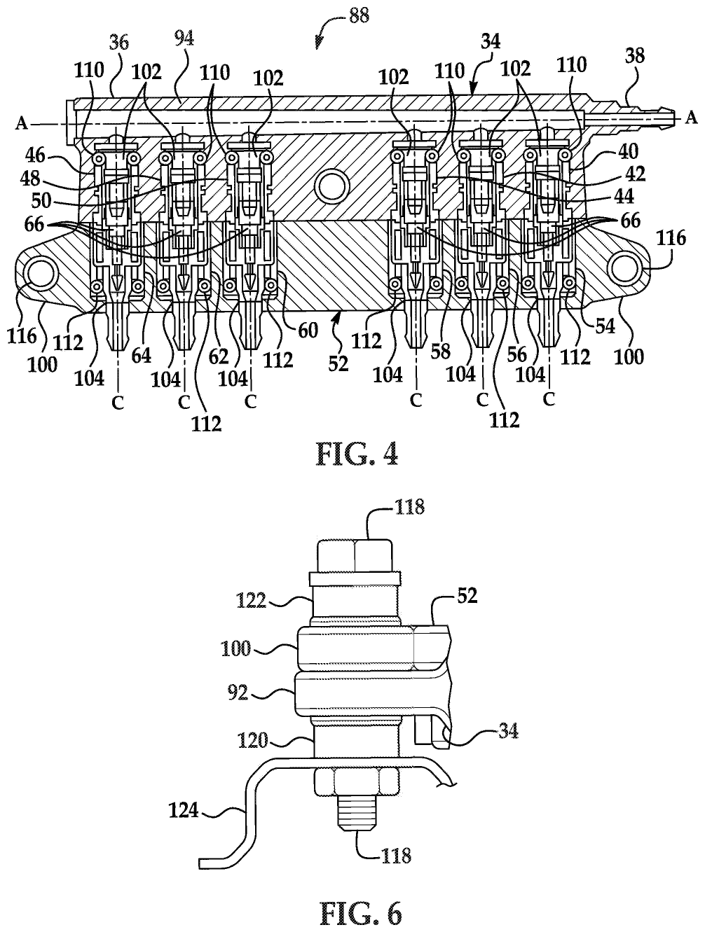

With reference to FIGS. 3-4, the first manifold section 34 includes the pipe 36, the inlet 38, the first cylindrical tubes 40, 42, 44, 46, 48, 50, and two first bolt plates 92. The first manifold section 34 can be formed, e.g., injection-molded, as a single unit. The first manifold section 34 is a single piece, i.e., formed as a continuous unit without internal seams.

The inlet 38 is fluidly connected to the pipe 36. The inlet 38 is in line with the axis A, i.e., the inlet 38 is elongated along the axis A, and a direction of flow defined by the inlet 38 is along the axis A. A diameter of the inlet 38 may be less than a smallest diameter of the pipe 36, as shown in FIG. 4.

The pipe 36 extends straight along the axis A and defines the axis A. The pipe 36 is sealed other than the inlet 38 and the first cylindrical tubes 40, 42, 44, 46, 48, 50; i.e., the only routes for fluid to enter or exit the pipe 36 is through the inlet 38 or one of the first cylindrical tubes 40, 42, 44, 46, 48, 50. The pipe 36 includes an outer wall 94. The outer wall 94 has a circular cross-section. The outer wall 94 is interrupted by the connections to the first cylindrical tubes 40, 42, 44, 46, 48, 50, as described below.

The pipe 36 includes a first longitudinal section 96 and a second longitudinal section 98. The first longitudinal section 96 encompasses a first portion of a cross-section of the pipe 36 that is elongated along the axis A; in other words, the first longitudinal section 96 encompasses a semicircular portion of the pipe 36 around the axis A. The second longitudinal section 98 encompasses a second portion of the cross-section of the pipe 36 opposite the first portion of the cross-section of the pipe 36; in other words, the second longitudinal section 98 encompasses the other semicircular portion of the pipe 36 around the axis A than the first longitudinal section 96. The first and second longitudinal sections 96, 98 completely form the pipe 36 and do not overlap. As shown in FIGS. 3 and 4, the first longitudinal section 96 is a bottom half of the pipe 36, and the second longitudinal section 98 is a top half of the pipe 36.

The first manifold section 34 includes at least three first cylindrical tubes 40, 42, 44, 46, 48, 50, e.g., at least five first cylindrical tubes 40, 42, 44, 46, 48, 50, e.g., six first cylindrical tubes 40, 42, 44, 46, 48, 50 as shown in the Figures, i.e., the first first cylindrical tube 40, the second first cylindrical tube 42, the third first cylindrical tube 44, the fourth first cylindrical tube 46, the fifth first cylindrical tube 48, and the sixth first cylindrical tube 50. The first cylindrical tubes 40, 42, 44, 46, 48, 50 are fluidly connected to and elongated from the pipe 36. For example, the first cylindrical tubes 40, 42, 44, 46, 48, 50 extend from the first longitudinal section 96 of the pipe 36. The first cylindrical tubes 40, 42, 44, 46, 48, 50 extend parallel to each other and transverse to the pipe 36, e.g., perpendicular to the pipe 36 as shown in the Figures. The first cylindrical tubes 40, 42, 44, 46, 48, 50 are spaced from each other along the axis A. The first cylindrical tubes 40, 42, 44, 46, 48, 50 are arranged in series along the pipe 36. The first first cylindrical tube 40 is closest to the inlet 38 along the axis A; the second first cylindrical tube 42 is adjacent the first first cylindrical tube 40 and the third first cylindrical tube 44; the third first cylindrical tube 44 is adjacent the second first cylindrical tube 42 and the fourth first cylindrical tube 46; the fourth first cylindrical tube 46 is adjacent the third first cylindrical tube 44 and the fifth first cylindrical tube 48; the fifth first cylindrical tube 48 is adjacent the fourth first cylindrical tube 46 and the sixth first cylindrical tube 50; and the sixth first cylindrical tube 50 is adjacent the fifth first cylindrical tube 48 and is farthest from the inlet 38. Each of the first cylindrical tubes 40, 42, 44, 46, 48, 50 can be equally spaced from the consecutive first cylindrical tubes 40, 42, 44, 46, 48, 50; for another example, first cylindrical tubes 40, 42, 44, 46, 48, 50 within subgroups can be equally spaced from each other, e.g., the first first cylindrical tube 40, second first cylindrical tube 42, and third first cylindrical tube 44 can be equally spaced from each other, and the fourth first cylindrical tube 46, fifth first cylindrical tube 48, and sixth first cylindrical tube 50 can be equally spaced from each other, as shown in the Figures. The cross-sectional areas of the first cylindrical tubes 40, 42, 44, 46, 48, 50 can be substantially equal to each other.

The pipe 36 has an increasing cross-sectional area from the first first cylindrical tube 40 to the sixth first cylindrical tube 50. The cross-sectional area of the pipe 36 increases continuously from the first first cylindrical tube 40 to the sixth first cylindrical tube 50. The pipe 36, e.g., the outer wall 94 of the pipe 36, has a circular cross-section, and the diameter of the circular cross-section increases from the first first cylindrical tube 40 to the sixth first cylindrical tube 50. The diameter of the circular cross-section of the pipe 36 (i.e., the internal diameter of the outer wall 94) increases continuously, i.e., without interruption, from the first first cylindrical tube 40 to the sixth first cylindrical tube 50. The generally increasing cross-sectional area of the pipe 36 allows the fluid apparatus 32 to provide an even flow rate and pressure through the second cylindrical tubes 54, 56, 58, 60, 62, 64. The targets for which the second cylindrical tubes 54, 56, 58, 60, 62, 64 supply fluid, e.g., the sensors 68, can thus receive a consistent and predictable supply of washer fluid.

The second manifold section 52 is fixed relative to the first manifold section 34. The second manifold section 52 includes the second cylindrical tubes 54, 56, 58, 60, 62, 64 and two second bolt plates 100. The second manifold section 52 can be formed, e.g., injection-molded, as a single unit. The second manifold section 52 is a single piece, i.e., formed as a continuous unit without internal seams.

The second manifold section 52 includes at least three second cylindrical tubes 54, 56, 58, 60, 62, 64, e.g., at least five second cylindrical tubes 54, 56, 58, 60, 62, 64, e.g., six second cylindrical tubes 54, 56, 58, 60, 62, 64 as shown in the Figures, i.e., the first second cylindrical tube 54, the second second cylindrical tube 56, the third second cylindrical tube 58, the fourth second cylindrical tube 60, the fifth second cylindrical tube 62, and the sixth second cylindrical tube 64. Each second cylindrical tube 54, 56, 58, 60, 62, 64 is aligned with and fluidly connected with a respective one of the first cylindrical tubes 40, 42, 44, 46, 48, 50, e.g., the first second cylindrical tube 54 with the first first cylindrical tube 40, the second second cylindrical tube 56 with the second first cylindrical tube 42, the third second cylindrical tube 58 with the third first cylindrical tube 44, the fourth second cylindrical tube 60 with the fourth first cylindrical tube 46, the fifth second cylindrical tube 62 with the fifth first cylindrical tube 48, and the sixth second cylindrical tube 64 with the sixth first cylindrical tube 50. In particular, each respective pairing of one of the first cylindrical tubes 40, 42, 44, 46, 48, 50 and one of the second cylindrical tubes 54, 56, 58, 60, 62, 64 defines a common axis C. The second cylindrical tubes 54, 56, 58, 60, 62, 64 extend parallel to each other and transverse to the pipe 36, e.g., perpendicular to the pipe 36 as shown in the Figures. The second cylindrical tubes 54, 56, 58, 60, 62, 64 are arranged in series along the pipe 36 in the same order as the respective first cylindrical tubes 40, 42, 44, 46, 48, 50. The second cylindrical tubes 54, 56, 58, 60, 62, 64 are spaced from each other along the axis A with the same spacing as the respective first cylindrical tubes 40, 42, 44, 46, 48, 50.

The cleaning system 80 includes at least three solenoid valves 66, e.g., at least five solenoid valves 66, e.g., six solenoid valves 66 as shown in FIG. 4. Each solenoid valve 66 is positioned to control flow through one of the first cylindrical tubes 40, 42, 44, 46, 48, 50 and then through the respective one of the second cylindrical tubes 54, 56, 58, 60, 62, 64. Each solenoid valve 66 is press-fit into the respective one of the first cylindrical tubes 40, 42, 44, 46, 48, 50 and into the respective one of the second cylindrical tubes 54, 56, 58, 60, 62, 64. The press-fit fixes the first manifold section 34 and the second manifold section 52 relative to one another. Each solenoid valve 66 extends along the respective common axis C from a first end 102 inside the respective first cylindrical tube 40, 42, 44, 46, 48, 50 to a second end 104 inside the respective second cylindrical tube 54, 56, 58, 60, 62, 64.

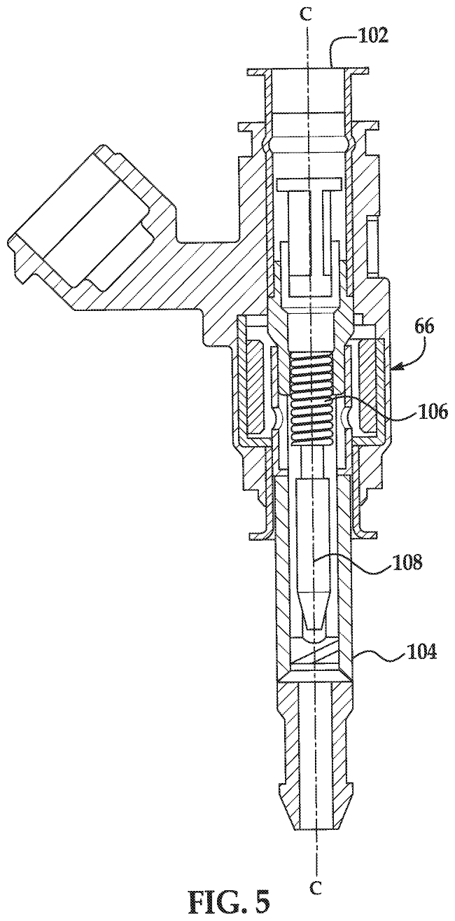

With reference to FIG. 5, each solenoid valve 66 is actuatable between an open position permitting flow and a closed position blocking flow from the respective one of the first cylindrical tubes 40, 42, 44, 46, 48, 50 to the respective one of the second cylindrical tubes 54, 56, 58, 60, 62, 64. The solenoid valves 66 are independently actuatable, i.e., can each be actuated without actuating the others. Each solenoid valve 66 includes a solenoid 106 and a plunger 108. Electrical current through the solenoid 106 generates a magnetic field, and the plunger 108 moves in response to changes in the magnetic field. Depending on its position, the plunger 108 permits or blocks flow through the respective pairing of one of the first cylindrical tubes 40, 42, 44, 46, 48, 50 and one of the second cylindrical tubes 54, 56, 58, 60, 62, 64.

Returning to FIG. 4, a first elastomeric bushing 110 is disposed inside each first cylindrical tube 40, 42, 44, 46, 48, 50 and contacts the respective first end 102 of the respective solenoid valve 66. A second elastomeric bushing 112 is disposed inside each second cylindrical tube 54, 56, 58, 60, 62, 64 and contacts the respective second end 104 of the respective solenoid valve 66. The first and second elastomeric bushings 110, 112 are positioned to cushion vibrations imparted by the solenoid valves 66 along the respective common axes C to the first and second manifold sections 34, 52. The first and second elastomeric bushings 110, 112 are made of an elastomeric material. Elastomeric materials generally have a low Young's modulus and a high failure strain.

With reference to FIGS. 3 and 6, the first manifold section 34 includes the first bolt plates 92, and the second manifold section 52 includes the second bolt plates 100. The first and second bolt plates 92, 100 are flat and parallel to a plane including all the common axes C. The first bolt plates 92 each include a first bolt hole 114, and the second bolt plates 100 each include a second bolt hole 116. A bolt 118 extends through each first bolt hole 114 and the respective second bolt hole 116. The bolts 118 extend orthogonal to the planes defined by the first bolt plates 92 and the second bolt plates 100. Along with the press-fit of the solenoid valves 66, the bolts 118 fix the first manifold section 34 and the second manifold section 52 relative to one another.

With reference to FIG. 6, each bolt 118 extends through a third elastomeric bushing 120, a fourth elastomeric bushing 122, and a mounting bracket 124. Each bolt 118 extends through, in order, the third elastomeric bushing 120, the first bolt hole 114 of the first bolt plate 92, the second bolt hole 116 of the second bolt plate 100, the fourth elastomeric bushing 122, and the mounting bracket 124, with the mounting bracket 124 alternatively contacting the third elastomeric bushing 120 instead of the fourth elastomeric bushing 122. The third elastomeric bushing 120 contacts the first manifold section 34 and is spaced from the second manifold section 52, and the fourth elastomeric bushing 122 contacts the second manifold section 52 and is spaced from the first manifold section 34. The mounting bracket 124 fixes the manifold relative to the housing 76. The third and fourth elastomeric bushings 120, 122 are made of an elastomeric material.

The disclosure has been described in an illustrative manner, and it is to be understood that the terminology which has been used is intended to be in the nature of words of description rather than of limitation. The adjectives “first,” “second,” “third,” “fourth,” “fifth,” and “sixth” are used throughout this document as identifiers and are not intended to signify importance, order, or quantity. Many modifications and variations of the present disclosure are possible in light of the above teachings, and the disclosure may be practiced otherwise than as specifically described.

What is claimed is:

1. A fluid apparatus comprising:
a first manifold section including a straight pipe defining an axis, an inlet fluidly connected to the pipe and in line with the axis, and at least three first cylindrical tubes fluidly connected to and elongated from the pipe;
a second manifold section fixed relative to the first manifold section and including at least three second cylindrical tubes each aligned with a respective one of the first cylindrical tubes; and
at least three solenoid valves each press-fit into a respective one of the first cylindrical tubes and into a respective one of the second cylindrical tubes.

2. The fluid apparatus of claim 1, wherein each solenoid valve controls flow from the pipe through the respective one of the first cylindrical tubes and then through the respective one of the second cylindrical tubes.

3. The fluid apparatus of claim 1, wherein the solenoid valves are independently actuatable.

4. The fluid apparatus of claim 1, wherein the pipe has an increasing cross-sectional area along the axis from the first cylindrical tube closest to the inlet to the first cylindrical tube farthest from the inlet.

5. The fluid apparatus of claim 1, wherein the pipe has a circular cross-section.

6. The fluid apparatus of claim 5, wherein a diameter of the circular cross-section continuously increases from the first cylindrical tube closest to the inlet to the first cylindrical tube farthest from the inlet.

7. The fluid apparatus of claim 1, wherein cross-sectional areas of the first cylindrical tubes are substantially equal to each other.

8. The fluid apparatus of claim 1, wherein each respective pairing of one of the first cylindrical tubes and one of the second cylindrical tubes defines a common axis.

9. The fluid apparatus of claim 8, wherein each solenoid valve extends along the respective axis from a first end inside the respective first cylindrical tube to a second end inside the respective second cylindrical tube, the fluid apparatus further comprising an elastomeric bushing inside each first cylindrical tube and contacting the respective first end of the respective solenoid valve.

10. The fluid apparatus of claim 9, wherein each elastomeric bushing is a first elastomeric bushing, the fluid apparatus further comprising a second elastomeric bushing inside each second cylindrical tube and contacting the respective second end of the respective solenoid valve.

11. The fluid apparatus of claim 1, wherein the first manifold section includes a first bolt hole, the second manifold section includes a second bolt hole aligned with the first bolt hole, the fluid apparatus further comprising a bolt extending through the bolt holes, and an elastomeric bushing through which the bolt extends.

12. The fluid apparatus of claim 11, wherein the elastomeric bushing is a third elastomeric bushing, the fluid apparatus further comprising a fourth elastomeric bushing through which the bolt extends, wherein the third elastomeric bushing contacts the first manifold section and is spaced from the second manifold section, and the fourth elastomeric bushing contacts the second manifold section and is spaced from the first manifold section.

13. The fluid apparatus of claim 1, wherein the first cylindrical tubes extend parallel to each other and transverse from the pipe.

14. The fluid apparatus of claim 13, wherein the first cylindrical tubes are arranged in series along the pipe with each first cylindrical tube equally spaced from the consecutive first cylindrical tubes.

15. The fluid apparatus of claim 1, wherein the pipe is sealed other than the inlet and the first cylindrical tubes.

16. The fluid apparatus of claim 1, wherein the first cylindrical tubes extend perpendicular to the pipe.

17. The fluid apparatus of claim 1, wherein the first manifold section is a single piece, and the second manifold section is a single piece.

18. The fluid apparatus of claim 1, further comprising a pump fluidly connected to the inlet.
